(19) United States
(12) Patent Application Publication
(10) Pub. No.: US 2012/0228566 A1
(43) Pub. Date: Sep. 13, 2012

(54) MATERIAL

(76) Inventor: Steven John Savage, Jarfalla (SE)

(21) Appl. No.: 13/509,930

(22) PCT Filed: Nov. 15, 2010
(86) PCT No.: PCT/SE2010/000275

§ 371 Date: May 15, 2012

(30) Foreign Application Priority Data
Nov. 16, 2009 (SE) 0901 449-9

(51) Int. Cl. G02B 1/04

(52) U.S. Cl. 252/582

(57) ABSTRACT

The present invention concerns a solid transparent OPL-material, (OPL; Optical Power Limiting). It comprises a solid polymer material that constitutes a matrix with therein dispersed particles. The particles are either nickel-ferrite(NiFe₂O₄), carbon black (C) or fullerene (C₆₀)—The diameter of the particles is preferably in the sizes about 5-50% of the wavelength of the laser light that protection against is wanted. Those polymers as matrix materials yield OPL materials that both reveal good OPL-properties and good durability and stability during exposure to laser light irradiation of high intensity together with the said particles.

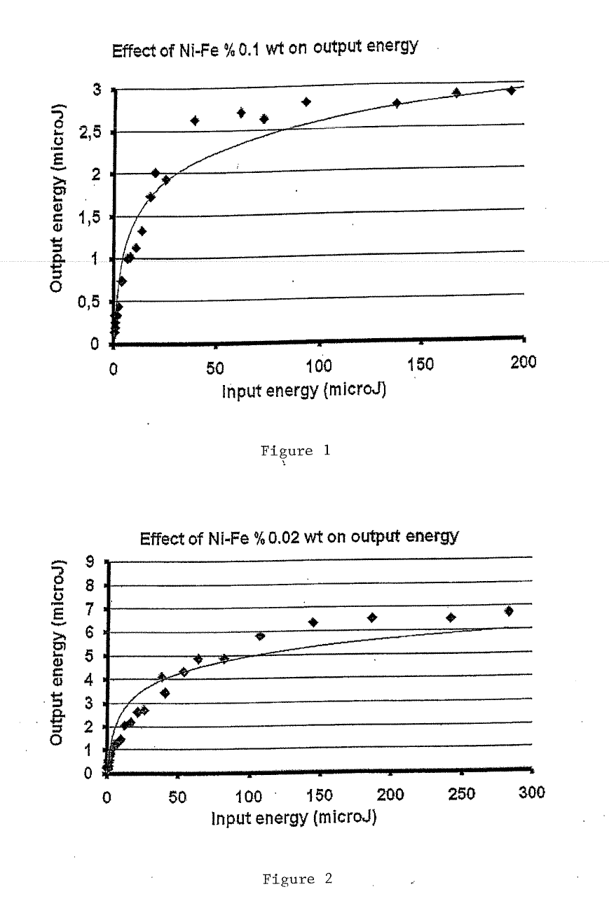

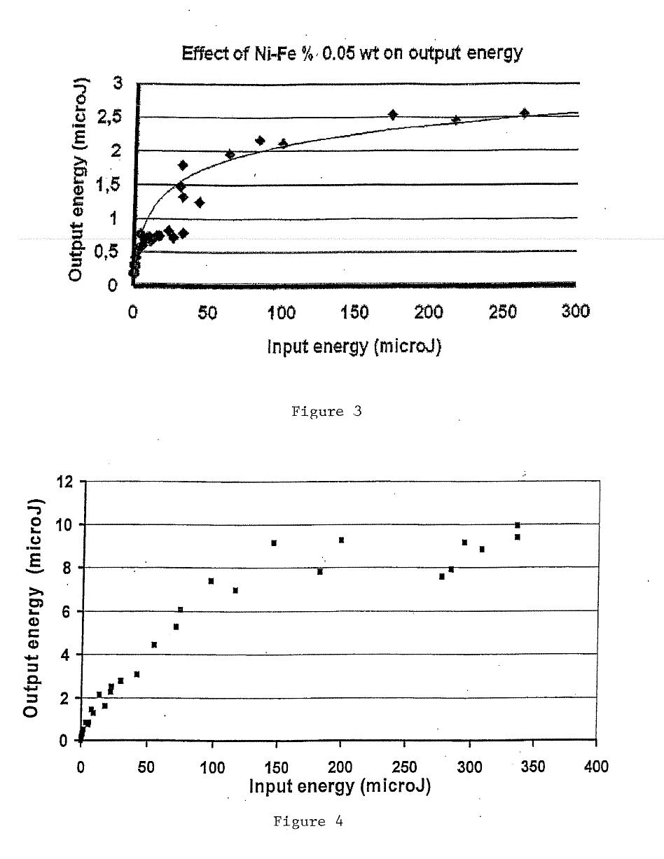

### BACKGROUND

Lasers are an increasing problem, in both civil and military situations. Irradiation with high energy laser light can cause injuries and damage, on both equipment and humans. Optical sensors that are used with weapons sights and also an operator's eye behind a sight with optical sensors and lenses risks getting damaged by lasers. A laser can scan a larger area and when a threat in the form of a reflector is registered, the effect is increased and the sensor or the eye behind it is damaged. Even in industrial laser light applications mistakes may cause consequences in form of eye injuries.

Laser light is used today to dazzle humans for example for the purpose of stopping a vehicle. The difference between temporary dazzling and causing permanent eye injuries is small. In recent year, civilian air traffic has reported a large number of incidents caused by irradiation by laser light. A laser that is powerful enough to blind pilots in an aeroplane can be bought by anyone completely legally. A laser light exposure to an unprotected eye at 800 nm for more than 0.25 seconds yields permanent eye damages.

To protect optical sensors today electrical sights are used which may be given boundaries wherein the depiction intensity is limited. The output effect may be regulated to assure that a user is not exposed to damaging high intensities. The problem still remains in that the registration sensors are exposed to high intensities and can be damaged. There are absorbing pigments which can be used to filter or block certain fixed wavelengths. The problem with them is that they reduce the contrast in the depiction of the surroundings, reduce the total light intensity and that it is necessary to know in advance what wavelengths that it is important to have protection against.

There are a few materials which have optical power limiting properties. They are usually grouped under the term OPL material (Optical Power Limiting) that means that they have the ability to transmit light of low intensities and limit or block transmission of light of high intensities. They are active within a certain wavelength interval. Theoretically they could work as protection against laser light irradiation. Useful as protection against laser irradiation of high intensity are the materials which absorb visible light and wavelengths near visible wavelength, in the infra red (IR)-area. There are materials that exhibit OPL-properties in solutions. For example ZnTe/CdSe, Pt-compounds, single walled nanotubes and titanium doped silicon glass. These are either toxic or difficult to manufacture. They are dispersed in a fluid, as for example carbon disulfide, but the particles may gradually agglomerate and sink down to the bottom. Even if this problem could be solved, the problem with the difficulty to make any usable laser protection application with a fluid in, remains. At low temperatures the viscosity of the fluids increases and they may also freeze. In practical use bubbles may form in the fluid and the laser protection is then not reliable and transparency may vary greatly during normal use. Liquid-based OPL materials do not work in any practical laser protection application.

It also known to use thin layers of alloy elements, as thin as a few of tenths of micrometers, where the layer the alloy concentration is very high or consists solely of only the alloy material that gives the laser protection. A major difference between the material that this application concerns and former known materials is that the layers according to prior known materials turns opaque from irradiation with light of high intensity. The layers further give a certain amount of dark toning to the panes, lenses or similar applications therewith. The invention differs essentially from previous known technique in that the glass or pane not is dark toned and further in that it does not becomes opaque after irradiation.

### The Invention

The present invention comprises a solid transparent laser protecting optical power limiting material, an OPL-material. It comprises a solid transparent polymer material which forms a matrix and therein dispersed particles of nickelferrite, (NiFe₂O₄), carbon black (C) or fullerene (C₆₀). Particularly for nickel-ferrite surprisingly good results have been achieved. The diameter of the particles is preferably in the sizes about 5-50% of the wavelength of the laser light that protection against is wanted. Particles with different diameters form together with the polymer matrix a broad spectrum laser protecting OPL-material. The polymer for the matrix is either chitin or polymethyl methacrylate, PMMA. Polymers as matrix materials yield OPL materials that both reveal good OPL-properties and good durability and stability during exposure to laser light irradiation of high intensity. Said polymers, chitin and PMMA, resists both resists grinding as long as it takes to produce a good distribution of the particles sizes. Grinding times necessary may for example range from about one hour for smaller batches which yields a few of grams OPL-alloy, but can for bigger batches be up to 24 hours.

To use nickel-ferrite alloyed with PMMA or chitin yields a robust transparent construction material with excellent OPL-properties, said material being well suited for panes for aeroplanes and lenses. The material does not lose its transparency with repeated irradiation. This distinguishes the material from previously known OPL-materials.

The material according to the invention renders the possibility to make thicker structures, both lenses and panes for aeroplanes etc. that have a thickness of up to about 5 cm and even thicker and that not is dependent on the angle of the incoming light for its function and it protects a user against dangerous irradiation even at repeated exposures. This is possible by the fact that nickel-ferrite and PMMA or nickel-ferrite and chitin functions well when ground together, and may be formed to a mechanical alloy, said alloy providing good contact between the alloy substance nickel-ferrite and the matrix comprising PMMA or chitin. The materials stick together and good contact between them is achieved whereby the alloyed material is therefore transparent both before and after exposure to high energy laser radiation.

Nickel-ferrite is effective even at low concentrations, the measurements that have been done in the interval 0.02-0.1 weight percent nickel-ferrite and are shown in this patent application reveal excellent values especially within this interval. Furthermore the measurements showed that the OPL-properties are not linear within this interval, but we have found that particularly nickel-ferrite yields excellent properties and excellent transparency within this interval.

The combination of materials is performed through a form of mechanical alloying. Mechanical alloying is a per se known manufacturing method to make special alloys of metals. When the method is used for alloying of polymeric materials completely different process parameters are required than with is required when alloying metals. Mechanical alloying can briefly be described as a process where materials are ground milled together and thereafter pressed together under high temperature and during high pressure. The grains in the materials fuse together in the grain boundaries.

The polymers are ground in their glass state together with particles, the particles consisting of nickel-ferrite, carbon black or fullerene, to a fine powder. By the grinding, a dispersion of particle sizes is yielded among the alloy materials used, it is thereby possible to produce an OPL-alloy with broad spectral limitation. The laser light that it is interesting to have protection against is light in the wave length area approximately 350 nm to 1100 nm.

After the grinding the powder of polymer and alloy substance is pressed together preferably under vacuum to a mechanical alloy in which the particles of the OPL-material are locked in the polymer matrix and can not form agglomerates. The temperature during the pressing step should be near but not exceed the polymer melting point. Air bubbles and air voids in the final material scatter the light and give a milky appearance. This is avoided by the temperature being dropped first after the vacuum has been released.

Many polymers are hydrophilic and water works as softener. An increased amount of water transfers the phase transition temperatures towards lower temperature values. A dry polymer is therefore often easier to grind and does not demands external cooling to the same extent as a damp. Even by the pressure step after the grinding step a dry material is preferable as water may cause water vapour blisters in the alloy. The bubbles and voids cause a milky appearance to the alloy.

### The Drawings

The drawings shows results from made trials.

Drawing 1 Output light energy as a function of input light energy at 0.1 weight % nickel-ferrite in PMMA.

Drawing 2 Output light energy as a function of input light energy at 0.05 weight % nickel-ferrite in PMMA

Drawing 3 Output light energy as a function of input light energy at 0.02 weight % nickel-ferrite in PMMA

Drawing 4 Output light energy as a function of input light energy at 0.1 weight % fullerene (C₆₀) in PMMA.

From the drawings the conclusion may be made that for every concentration of dispersed particles there are a certain value if light intensity at which almost no light energy over this intensity value is transmitted through the OPL material. The measurements are made at 532 nm, which is the wavelength that is most dangerous to a human eye.

For the tests an alloy of nickel-ferrite (NiFe₂O₄) in PMMA (polyoximethylmethacrylate, Plexi glass) was prepared. By the tests PMMA was dried at 80° C. for 3-4 hours prior to grinding, in order to remove any water which may be present in the polymer. After the pressing step that was performed in vacuum, the vacuum was released before the alloy was allowed to cool. The alloy had excellent normal transparency with a very slight yellow tone. The alloy exhibited OPL properties, as demonstrated. Similar tests were made with fullerene and in drawing 4 it is shown that the same the same type of curve for transmitted light intensity as a function of input light intensity was obtained as for nickel-ferrite.

When a high intensity limiting effect is desirable a practical limit for it is given by the amount of particle of about 1 weight % dispersed particles, where the materials will be so dark due to the amount of particles that it does not works in practical applications as lenses, panes for aeroplanes and other things.

1. Optical power limiting material comprising a matrix of a transparent polymer and in the matrix dispersed particles characterized in that the particles consists of nickel-ferrite.

2. Optical power limiting material according to claim 1 characterized in that the polymer either being PMMA or chitin.

3. Optical power limiting material according to claim 1 characterized in that the dispersed particles preferably has a diameter of 5-50% of the wave length or the wave lengths of the light that the material is intended to dampen high intensities of.

4. Optical power limiting material according to claim 1 characterized in that the particles constitute between 0.02 and 0.1 weight percent of the material.

5. Optical power limiting material according to claim 1 characterized in that the particles constitute 0.05 weight percent of the material.

6. Optical power limiting material according to claim 2 characterized in that the dispersed particles preferably has a diameter of 5-50% of the wave length or the wave lengths of the light that the material is intended to dampen high intensities of.

7. Optical power limiting material according to claim 2 characterized in that the particles constitute between 0.02 and 0.1 weight percent of the material.

8. Optical power limiting material according to claim 3 characterized in that the particles constitute between 0.02 and 0.1 weight percent of the material.

9. Optical power limiting material according to claim 2 characterized in that the particles constitute 0.05 weight percent of the material.

10. Optical power limiting material according to claim 3 characterized in that the particles constitute 0.05 weight percent of the material.

11. Optical power limiting material according to claim 4 characterized in that the particles constitute 0.05 weight percent of the material.
